(19) United States
(12) Patent Application Publication
(10) Pub. No.: US 2008/0320180 A1
(43) Pub. Date: Dec. 25, 2008

(54) USB host, USB slave, wireless communication system, and data transfer method

(75) Inventor: Masao Manabe, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/155,713

(22) Filed: Jun. 9, 2008

(30) Foreign Application Priority Data
Jun. 21, 2007 (JP) 2007-163450

(51) Int. Cl. G06F 13/18

(52) U.S. Cl. 710/33

(57) ABSTRACT

A data transfer method between a USB host and a USB slave (DWA), wherein the USB host sends data transfer request information and transfer data to the USB slave in one data transfer unit based on schedule information, the data transfer request information specifying data transfer to be requested, and the schedule information determining a schedule for data transfer with the USB slave; and the USB slave receives the data transfer request information and the transfer data in succession from the USB host.

### BACKGROUND OF THE INVENTION

1. Field of the Invention

The present invention relates to a communication system or method to wirelessly communicate with a USB host based on the USB protocol.

2. Description of Related Art

Although the specifications of the USB protocol had been established on the assumption that a USB (Universal Serial Bus) would have been used in a wired environment, wireless USB technique that enables the USB to be unwired has been developed in recent years. The following specifications have been disclosed for a Certified Wireless USB.

“Wireless Universal Serial Bus Specification Revision 1.0”, [online], May 12, 2005 (searched on June 14, 2007) <URL:http://www.usb.org/developers/wusb/wusb_{—}2007_{—}0214.zip> A device wired adapter (which is called “DWA” hereinafter) is a kind of wireless hub to enable a wired USB device to be used as a wireless USB device by connecting the wired USB device in the downstream of the DWA. A DWA, together with the connected device, constitutes a USB slave, which communicates with a wireless USB host (which is called “USB host” hereinafter).

A transfer request is sent to a DWA as “Transfer Request”, and the DWA sends back a result of the request as “Transfer Result”. In the case of “OUT transfer” where data is transferred from a USB host to a DWA, the data is transferred subsequent to Transfer Request. In the case of “IN transfer” where data is transferred from a DWA to a USB host, the data is transferred subsequent to Transfer Result.

FIG. 12 is a sequence chart showing the OUT transfer procedure of a wireless USB system in related art, and FIG. 13 is a sequence chart showing the IN transfer procedure of a wireless USB system in related art.

In a wireless USB system, transfers are carried out in a time sharing manner, and the USB host controls each DWA by sending a MMC (Micro-scheduled Management Command) at regular intervals (S101, S104, S107, S109, S111, S114, S116, and S118) It instructs when and which wireless device (including DWA) carries out an IN/OUT transfer by using channel time allocation (called “CTA” hereinafter) which is contained in the MMC.

In a wireless USB system, the receiving side sends a handshake (acknowledgement) to the sending side to indicate whether the packet is received or not (S103, S106, S109, S113, S116, and S118). To put it more precisely, the handshake that is transferred from a USB host to a DWA is contained in the CTA of the next transfer instruction (S109, S116, and S118). Using this handshake, the sending side confirms the reception status, and if necessary, resends the packet.

In particular, when a USB host communicates with a DWA, the sending side confirms every single reception of Transfer Request (S102 and S112) and Transfer Result (S108 and S115) by the handshaking. In the case where an OUT data is transferred subsequent to Transfer Request (S102) in OUT transfer, a USB host starts the OUT data transfer (S105) after confirming the reception of Transfer Request through a handshake (S103) notified by the DWA. At this point, the transferred data may be allocated to several packets for the transfer. In the case where IN data follows Transfer Result (S115) in IN transfer, a DWA starts IN data transfer (S117) after confirming the reception of Transfer Result (S115) through a handshake (S116) notified by the USB host. At this point, the transferred data may be allocated to several packets for the transfer. After the data transfer, the DWA sends the IN data after confirming the handshake contained in CTA sent by the USB host.

One of the reasons why such procedure must be taken is that the transfers of Transfer Request/Transfer Result and data by a DWA are carried out by using bulk transfer in a wireless USB system. That is, when the packet length is shorter than an integral multiple of 512 bytes, that packet is recognized as the last packet in the bulk transfer. Therefore, Transfer Request/Transfer Result becomes the last packet since they have only 16 to 24 byte length. Furthermore, Transfer Request/Transfer Result in IN transfer and Transfer Request/Transfer Result in OUT transfer cannot be differentiated from one another unless the packet contents are checked. Therefore, in the case where data is transferred subsequent to Transfer Request or Transfer Result in a burst mode, if the forefront packet cannot be received, it cannot determine whether the next packet is Transfer Request or Transfer Result, or data.

For these reasons, a handshake needs to be confirmed for every transmission and reception of Transfer Request/Transfer Result.

Since a handshake needs to be confirmed for every transmission and reception of Transfer Request/Transfer Result in the communication system or method in the related art, the transmission and reception of handshakes have been a troublesome task. Furthermore, 10 μs gap (IFS) needs to be inserted between OUT transfer and IN transfer whenever the transfer direction is changed (1.8 μs is inserted in the case of the same direction). Therefore, the data transfer efficiency of data transfers between a USB host and a DWA has been significantly lower than that of data transfers between a USB host and a wired USB device that are connected through a wire. Furthermore, when the number of devices that are connected to a single wireless USB host is large, a scheduling time by one MMC also becomes longer. In addition, since Transfer Request/Transfer Result and data transfer need to be confirmed by handshakes, a time interval between Transfer Request/Transfer Result and data transfer becomes uselessly larger for the DWA for which several MMCs are always transferred between its Transfer Request/Transfer Result and data transfer.

Therefore, improvements in transfer efficiency in data transfer procedure between a USB host and a USB slave through wireless communication has been desired.

### SUMMARY

In accordance with one embodiment of the present invention, a USB host to wirelessly communicate with a USB slave includes a scheduling portion to generate schedule information, the schedule information determining a data transfer schedule, and a data control portion to send data transfer request information and transfer data to the USB slave in one data transfer unit based on the schedule information, the data transfer request information specifying data transfer to be requested. In this manner, the USB host can send data transfer request information and transfer data with one data transfer procedure.

In accordance with another embodiment of the present invention, a USB slave to wirelessly communicate with a USB host includes a host side control portion to receive data transfer request information and transfer data from the USB host in one data transfer unit, the data transfer request information specifying requested data transfer, and a device side control portion to transfer the transfer data to a data storage area based on the data transfer request information. In this manner, the USB slave can receive data transfer request information and transfer data with one data transfer procedure.

In accordance with another embodiment of the present invention, a data transfer method for a USB host that wirelessly communicates with a USB slave includes generating schedule information, the schedule information determining a data transfer schedule, and sending data transfer request information and transfer data to the USB slave in one data transfer unit based on the schedule information, the data transfer request information specifying data transfer to be requested. In this manner, the USB host can send data transfer request information and transfer data with one data transfer procedure.

In accordance with another embodiment of the present invention, a data transfer method for a USB slave that wirelessly communicates with a USB host includes receiving data transfer request information and transfer data from the USB host, in one data transfer unit, based on data transfer request information sent from the USB host, the data transfer request information specifying requested data transfer. In this manner, the USB slave can receive data transfer request information and transfer data with one data transfer procedure.

In accordance with one embodiment of the present invention, transfer efficiency in data transfer procedure between a USB host and a USB slave through wireless communication can be improved.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a configuration example of a system in which wireless USB communications are carried out in accordance with a first embodiment of the present invention;

FIG. 2 is a block diagram showing configuration examples of a USB host and DWA in accordance with the first embodiment of the present invention;

FIG. 3 shows a configuration example of a buffer contained in the DWA;

FIG. 4 is a sequence chart showing one example of OUT transfer in accordance with the first embodiment of the present invention;

FIG. 5 is a sequence chart showing one example of IN transfer in accordance with the first embodiment of the present invention;

FIG. 6 shows a flow of packets in OUT transfer in time series;

FIG. 7 shows a flow of packets in IN transfer in time series;

FIG. 8 is a flowchart showing an example of a process flow in a mass storage class;

FIG. 9A is a sequence chart showing data transfer procedure between a mass storage class host and a mass storage device in OUT transfer;

FIG. 9B is a sequence chart showing data transfer procedure between a mass storage class host and a mass storage device in IN transfer;

FIG. 9C is a sequence chart showing data transfer procedure between a mass storage class host and a mass storage device, in which no data transfers are carried out, but commands are carried out;

FIG. 10 shows a configuration example of a system in which a wireless USB in accordance with one embodiment of the present invention is applied to mass storage class devices;

FIG. 11A is a sequence chart showing one example of OUT transfer in accordance with a second embodiment of the present invention;

FIG. 11B is a sequence chart showing one example of IN transfer in accordance with a second embodiment of the present invention;

FIG. 12 is a sequence chart showing OUT transfer procedure of a wireless USB in related art; and

FIG. 13 is a sequence chart showing the IN transfer procedure of a wireless USB in related art.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

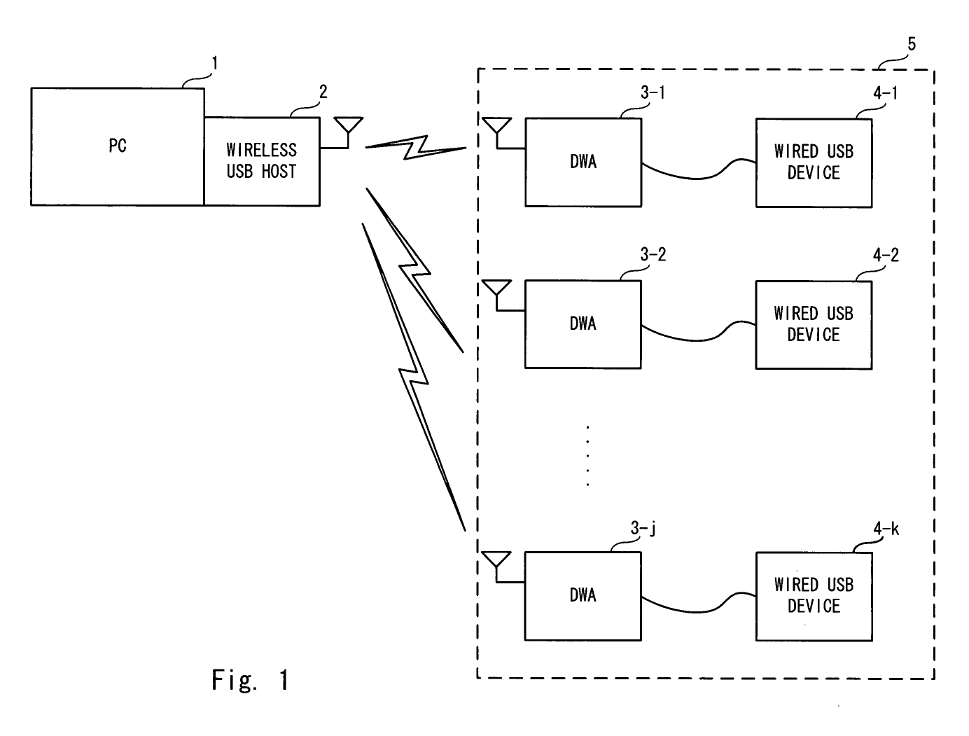

Embodiments of the present invention are explained hereinafter with reference to the drawings. To simplify the explanation, the descriptions and drawings are partially omitted or simplified as appropriate. In the drawings, the same signs are assigned to the components and equivalent portions having the same structure or function, and their explanations are omitted. Furthermore, there are several identical components in the present specification. Therefore, when these components needs to be differentiated from each other, the sign “-n (n is integer greater than 0)” is added to the original sign to differentiate one from others. For example, FIG.1 shows a plurality of DWAs 3-1, 3-2, . . . , 3-j. For example, when explanation is made with reference to FIG. 1, the term “DWA 3” means any one or ones of DWAs 3-1, 3-2, . . . , 3-j, and the term “DWA 3-1 (or DWA 3-2)” is used to differentiate the DWA 3-1 (or DWA 3-2) from other DWAs.

In the following explanation, the term “OUT transfer” means data transfer from a USB host to a USB slave, and the term “IN transfer” means data transfer from a USB slave to a USB host. OUT transfer and IN transfer are data transfer units that are used when a USB host makes a schedule for data transfer. The receiving side sends a handshake for each single OUT transfer or IN transfer. Furthermore, assume that the number of packets and defined packet size that can be transferred in one data transfer unit were determined in advance. Assume also that if packet size is smaller than the defined packet size, that packet is indicated as the last packet. Furthermore, data transferred in OUT transfer is called “OUT data”, and data transferred in IN transfer is called “IN data”. In the explanation, the OUT data and IN data indicate only the data portion to be transferred, and do not include control information such as data transfer request information.

In accordance with one embodiment of the present invention, data transfer procedure between a wireless USB host (called “USB host” hereinafter) and a USB slave through wireless communication is carried out in the following manner. Schedule information is information determining a schedule for data transfer with a USB slave. In OUT transfer, a USB host sends data transfer request information and transfer data to a USB slave in one data transfer unit based on the schedule information. The USB slave receives the data transfer request information and transfer data in succession in the one data transfer unit from the USB host. Furthermore, in IN transfer, the USB host requests the USB slave for data transfer. In response to the request, the USB slave sends the transfer data and data transfer result information, which indicates data acquisition result for the request, to the USB host in one data transfer unit. The USB host receives the transfer data transferred in response to the request, and the data transfer result information from the USB slave in the one data transfer unit. The data transfer request information is information specifying the contents of data transfer that is requested by the USB host to the USB slave. For example, Transfer Request is one example of data transfer request information. Further, data transfer result information is information indicating the result of data transfer requested by a USB host. For example, Transfer Result is one example of data transfer result information.

With these procedures, data transfer request information and transfer data, or data transfer result information and transfer data can be transferred in one data transfer unit. In this manner, the number of handshakes and the number of data transfer direction changes or the number of idle times between Transfer Request/Transfer Result and transfer data are reduced. Consequently, it increases data transfer efficiency.

In the following embodiments, a case where a USB slave is composed of wired USB devices and relay devices, and a case where a USB device is capable of wireless communication by itself are explained as examples. However, the present invention is not limited to those USB slaves, and applicable to other structures, provided that the USB slave can wirelessly communicate with a USB host.

### First Embodiment

The relay device is a DWA as an example in a first embodiment, and a wireless communication system or method that is used between a USB host and the DWA is explained hereinafter. Information that indicates the request/result of data transfer, and transfer data are transferred in a burst mode in this embodiment. Furthermore, the wired USB device is a data storage area.

FIG. 1 shows a configuration example of a system in which wireless USB communications are carried out in accordance with a first embodiment of the present invention. A personal computer (PC) 1 includes a USB host 2. Furthermore, DWAs 3-1 to 3-j are connected to wireless USB devices 4-1 to 4-k (j and k are integers greater than 0). The USB host 2 wirelessly communicates with the wired devices 4. FIG. 1 shows a case where the USB slave 5 is composed of the DWAs 3 and wired devices 4. Incidentally, although each DWA 3 is connected to one wired device 4 in the example of FIG. 1, it may be connected to plural wired devices 4 in other examples. Furthermore, although the DWA 3 is connected to the wired device 4 in the example, it may be connected to other devices in other examples, provided that the DWA 3 can connect to and control those devices.

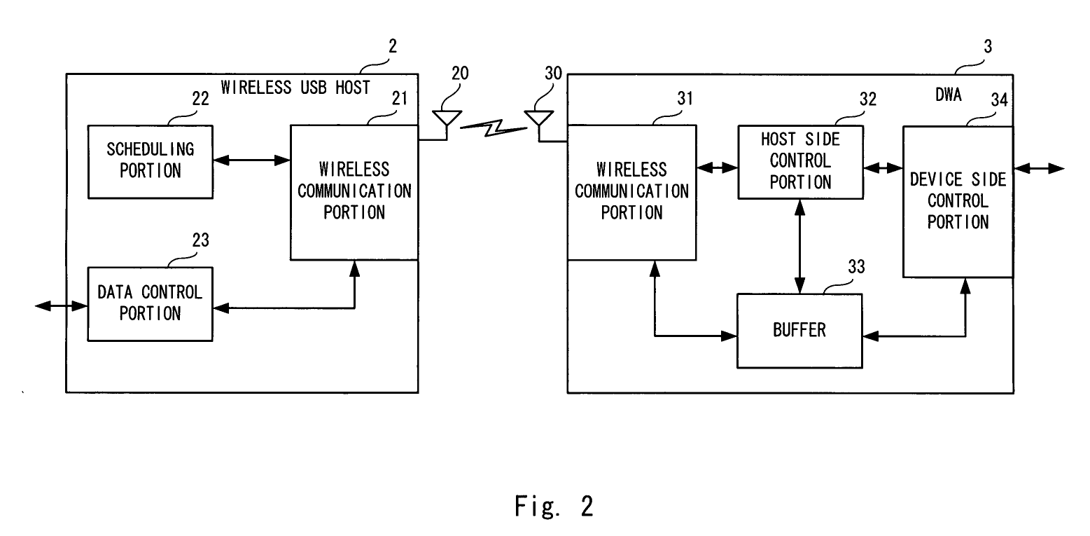

FIG. 2 is a block diagram showing configuration examples of a USB host and DWA in accordance with the first embodiment of the present invention. A USB host 2 shown in FIG. 2 includes an antenna 20, a wireless communication portion 21, a scheduling portion 22, and a data control portion 23. The wireless communication portion 21 converts data to be transferred into wireless data, demodulates received wireless data, and carries out other processes necessary for wireless communication to wirelessly communicate with the DWA 3. In the following explanation, when the scheduling portion 22 or data control portion 23 communicates with the DWA 3, the communication is carried out through the wireless communication portion 21 and antenna 20 even if it is not described specifically.

The scheduling portion 22 generates scheduling information that determines a schedule for data transfer with the DWA 3. Specifically, the scheduling portion 22 generates a MMC as the schedule information. The generated MMC is delivered to each DWA 3 by the wireless communication portion 21.

The data control portion 23 controls OUT transfer and IN transfer based on the schedule information. In OUT transfer, the data control portion 23 sends data transfer request information and OUT data in succession to the DWA 3. Specifically, the data control portion 23 sends at least one packet(s), to which both data transfer request information and OUT data are allocated, in one OUT transfer. Furthermore, in IN transfer, the data control portion 23 requests data transfer from the wired device 4 by sending data transfer request information to the DWA 3. Then, the data control portion 23 receives transfer data transferred from the wired device 4 in response to the request and data transfer result information, which indicates acquisition result for the requested data, in succession from the DWA 3. Specifically, the data control portion 23 receives at least one packet(s), to which both IN data and data transfer result information are allocated, in one IN transfer.

Furthermore, the data control portion 23 determines whether retransmission should be carried out or not based on a handshake and data transfer result information sent from the DWA 3, and instructs the scheduling portion 22 accordingly.

Furthermore, the DWA shown in FIG. 2 includes an antenna 30, a wireless communication portion 31, a host side control portion 32, a buffer 33, and a device side control portion 34. The wireless communication portion 31 converts data to be transferred into wireless data, demodulates received wireless data, and carries out other processes necessary for wireless communication to wirelessly communicate with the USB host 2. In the following explanation, when the host side control portion 32 communicates with USB host 2, the communication is carried out through the wireless communication portion 31 and antenna 30 even if it is not described specifically.

The host side control portion 32 receives scheduling information from the USB host 2, gets hold of the timings of OUT transfer and IN transfer that are carried out by the host side control portion 32 in itself from the scheduling information, and carries out control accordingly. In OUT transfer, the host side control portion 32 receives data transfer request information and transfer data in succession from the USB host 2. Specifically, the host side control portion 32 receives at least one packet(s), to which both data transfer request information and OUT data are allocated, in one OUT transfer. Furthermore, in IN transfer, the host side control portion 32 sends transfer data, which is transferred from the wired device 4 in response to the request notified in the data transfer request information from the USB host, and data transfer result information, which indicates data acquisition result for the request, to the USB host 2 in succession. Specifically, the host side control portion 32 receives at least one packet(s), to which both IN data and data transfer result information are allocated, in one IN transfer.

The buffer 33, which is a storage area to temporally store data, temporally stores packets that are transferred from or to the USB host 2.

The device side control portion 34 controls transaction process from the DWA 3 to the wired device 4. Specifically, in OUT transfer, it transfers OUT data stored in the buffer 33 to the wired device 4. Furthermore, in IN transfer, it reads out data specified by the data transfer request information, and stores that data with data transfer result information, which indicates data acquisition result for the request, in the buffer 33. The IN data and data transfer result information stored in the buffer 33 are sent to the USB host 2 by the host side control portion 32.

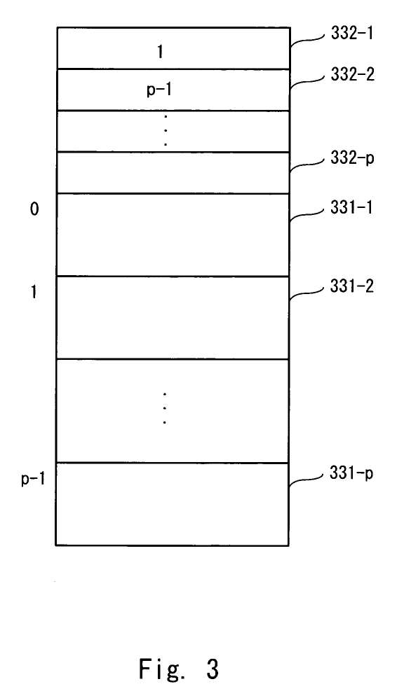

A configuration example of the buffer 33 is explained hereinafter. FIG. 3 shows a configuration example of a buffer contained in DWA. The buffer 33 includes p storage areas 331 which are divided into the same number as that of wired devices 4 to which the DWAs 3 are connected, and p allocation information 332 which indicate which storage area is used to store transfer data of which wired device 4. In the above explanation, p is the number of devices for which the DWAs 3 can connect, the storage areas 331 are differentiated from each other by the identification numbers (0, 1, . . . , p-1), the allocation information 332 are assigned to their respective wired devices 4, and each wired device 4 accesses a storage area 331 having the identification number written in their respective allocation information 332. FIG. 3 shows an example in which identification numbers are stored in the allocation information 332-1 and 332-2.

For example, in OUT transfer, the host side control portion 32 stores Transfer Request and OUT data and the like allocated to a received packet in an available storage area 331 of the buffer 33, and writes the identification number of that storage area in allocation information 332 when the destination is determined by the Transfer Request. Then, the host side control portion 32 instructs the device side control portion 34 to transfer the stored OUT data to the wired device 4. Furthermore, in IN transfer, the host side control portion 32 writes an identification number of an available storage area 331 in allocation information 332 of the wired device 4, for which the IN transfer is requested, based on data transfer request information. The device side control portion 34 stores data read out by the wired device 4 in the storage area 331 specified by the allocation information 332.

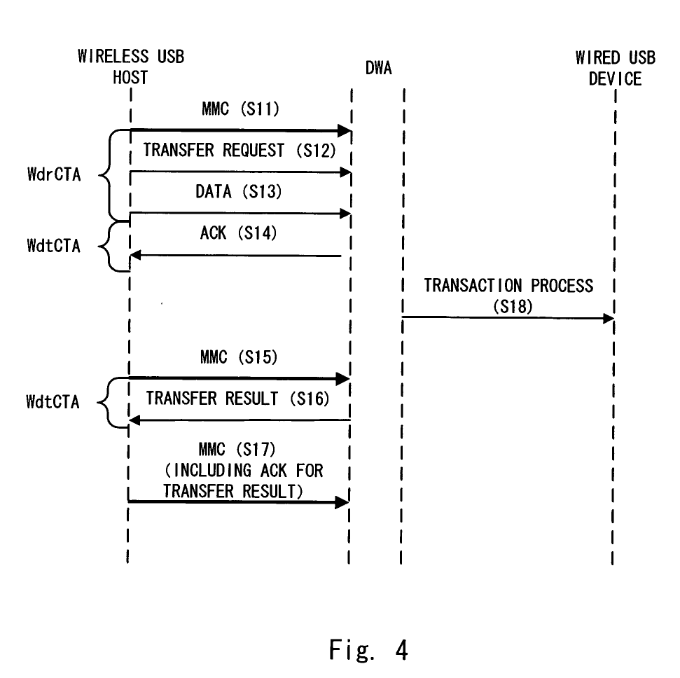

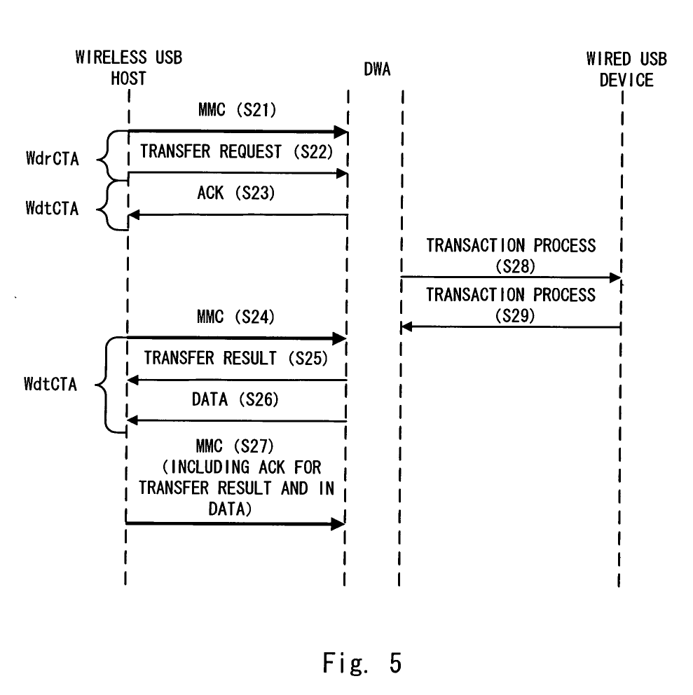

Next, operation in which communication procedure in accordance with this embodiment is applied to its wireless USB communication system is explained hereinafter with the assumption that data transfer request information is Transfer Request and data transfer result information is Transfer Result. FIG. 4 is a sequence chart showing one example of OUT transfer in accordance with the first embodiment, and FIG. 5 is a sequence chart showing one example of IN transfer in accordance with the first embodiment.

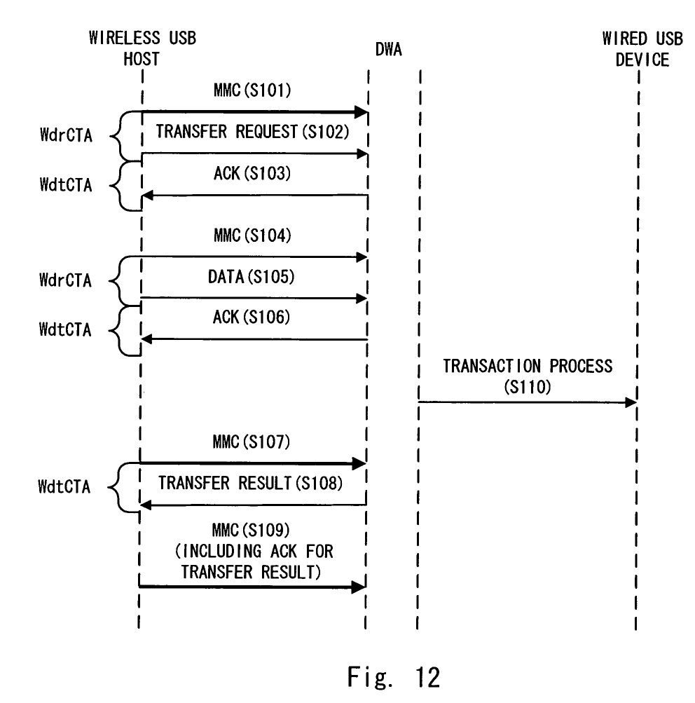

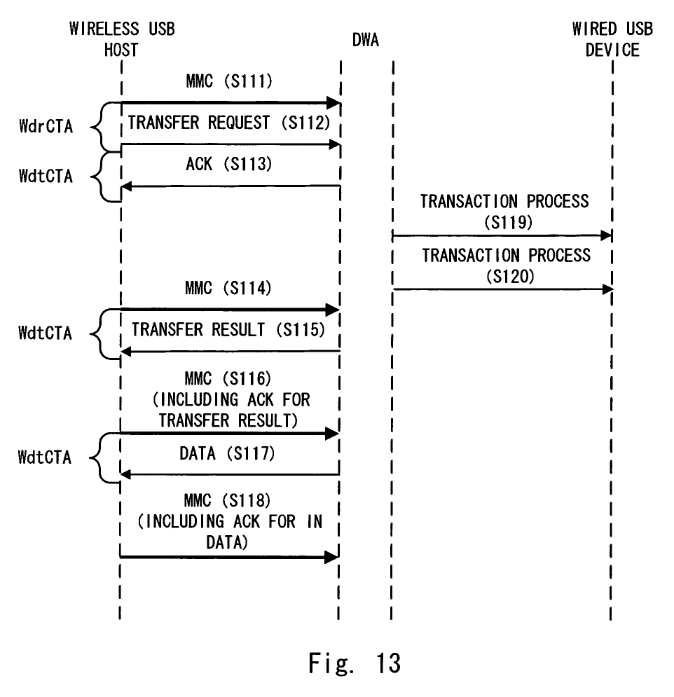

In contrast to FIGS. 12 and 13, OUT data is sent with Transfer Request in succession in a burst mode, and IN data is sent with Transfer Result in succession in a burst mode in this embodiment. Furthermore, the receiving side returns one collective handshake for the Transfer Request and its corresponding transfer data, or the Transfer Result and its corresponding transfer data. Furthermore, the operation is carried out on the assumption that if a burst transfer occurs at the timing when Transfer Request or Transfer Result is to be sent, the receiving side determines the transferred data is Transfer Request and its accompanying transfer data, or Transfer Result and its accompanying transfer data. In this manner, even if the forefront packet (Transfer Request or Transfer Result) is lost, it can still determine that the next data must be transfer data. Furthermore, since there is no need to add any additional information such as an identifier to OUT data or IN data, it can simplify the procedure.

Furthermore, packet length has been determined to be an integral multiple of 512 bytes for bulk transfer in a wireless USB system. Although the forefront packet is Transfer Request or Transfer Result when a burst transfer is carried out in this embodiment, the packet length of the forefront packet is adjusted to the predetermined packet length. In this manner, it does not violate the rules of bulk transfer mode in a wireless USB system. As a more specific adjusting method, padding may be used, or the vacant portion may be filled with transfer data. Although useless data is transferred when the padding is used, the time needed to transfer the padding is merely in the order of 1 μs with transfer rate of 480 Mbps even if the packet length is 512 bytes. Therefore, its transfer efficiency is better than that of the related art where 10 μs is inserted for transfer direction change. Firstly, operation in OUT transfer is explained with these assumptions.

In OUT transfer, the USB host 2 delivers a MMC containing a schedule for OUT transfer or the like to each DWA (S11). Then, the data control portion 23 allocates Transfer Result and OUT data to at least one packet(s) for the DWA 3 connected to the wired device 4 that made the request for the OUT transfer, and sends it to the DWA 3 (S12 and S13). At this point, the DWA 3 receives the packet(s), to which the Transfer Request and OUT data are allocated in succession in one data transfer unit. For example, more than two packets, i.e., one for Transfer Request allocation and at least one for OUT data allocation, may be used. OUT data may be allocated to more than one packets depending on data amount.

The DWA 3 sends a handshake after it receives the packet(s) in the one data transfer unit (S14). At this point, in the DWA 3, the OUT data which is transferred after the Transfer Request in succession is temporarily stored in the buffer 33, and then when all OUT data are transferred and the destination wired device 4 is determined by the Transfer Request, the device side control portion 34 carries out transaction process to transfer the OUT data to the wired device 4 (S18).

Then, the USB host 2 delivers a MMC containing a schedule for IN transfer that requests the transmission of Transfer Result or the like to the DWA 3 (S15). The DWA 3 allocates Transfer Result to a packet, and sends it (S16). The USB host 2 includes a handshake for the received Transfer Result in the next MMC, and delivers it (S17).

Next, in IN transfer, the USB host 2 delivers a MMC containing a schedule for OUT transfer of Transfer Request that requests IN transfer or the like to each DWA (S21). Then, the data control portion 23 allocates Transfer Request to a packet for the DWA 3 connected to the wired device 4 for which data acquisition was requested in the IN transfer, and sends it to the DWA 3 (S22). The DWA 3 sends a handshake after it receives the packet to which the Transfer Request is allocated (S23). In the DWA 3, the host side control portion 32 instructs the device side control portion 34 to carry out transaction process to read out IN data (S28), and stores the IN data in the buffer 33 (S29).

Then, the USB host 2 delivers a MMC containing a schedule for IN transfer or the like to the DWA 3 (S24). The DWA 3 allocates Transfer Result and IN data to at least one packet(s), and sends it (S25 and S26). IN data may be allocated to more than one packets depending on data amount. The USB host 2 includes a handshake for the received Transfer Result and IN data in the next MMC, and delivers it (S27).

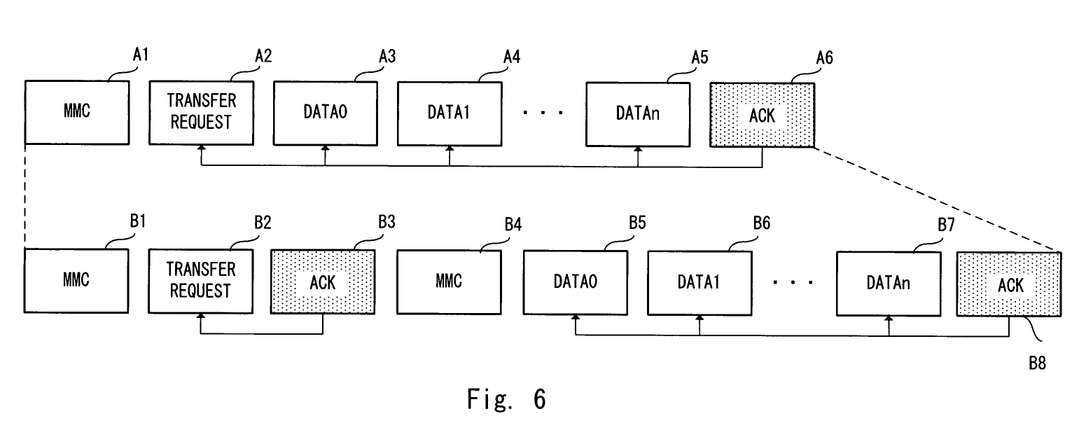

Next, packet transfer between a USB host 2 and a DWA 3 is explained hereinafter. FIG. 6 shows a flow of packets in OUT transfer in time series. In the figure, the upper part represents a flow in accordance with this embodiment, and the lower part represents a flow in the related art. In FIG. 6, time progresses from left to right. Furthermore, transmission is carried out from a DWA 3 to a USB host 2 for hatched packets, and carried out from a USB host 2 to a DWA 3 for other packets. In FIG. 6, a packet flow related to Transfer Result is omitted.

A USB host 2 first delivers a MMC (A1), and then sends Transfer Request (A2) and OUT data, i.e., DATA 0 (A3) to DATA n (A5) in succession to a DWA 3 in this embodiment in accordance with the present invention. The DWA 3 sends a collective handshake for the Transfer Request (A2) and OUT data (A3 to A5) in the form of an ACK (A6) to the USB host 2. On the other hand, a USB host first delivers a MMC (B1), and then sends Transfer Request (B2) to a DWA in the related art. The DWA sends a handshake for the Transfer Request (B2) in the form of an ACK (B3) to the USB host. Then, the USB host delivers a MMC (B4), and then sends OUT data, i.e., DATA 0 (B5) to DATA n (B7) to the DWA. The DWA sends a handshake for the OUT data (B5 to B7) in the form of an ACK (B8) to the USB host.

As shown in FIG. 6, the number of packets in the procedure to transfer the OUT data in this embodiment is fewer by two than in the procedure to transfer the same OUT data in the related art. Specifically, the packets for the ACK (B3) and MMC (B4) are eliminated. In addition, while the data transfer direction is changed three times in the related art, it is changed only once in this embodiment, and therefore it can also reduce the number of data transfer direction changes. Furthermore, it also means that the transfers of both Transfer Request and OUT data can be accomplished with one MMC. Therefore, additional Transfer Request and OUT data can be received with the next MMC. Considering the case where the number of devices connected to a wireless host becomes larger and the time scheduled by one MMC become longer, it improves the transfer efficiency of the DWA.

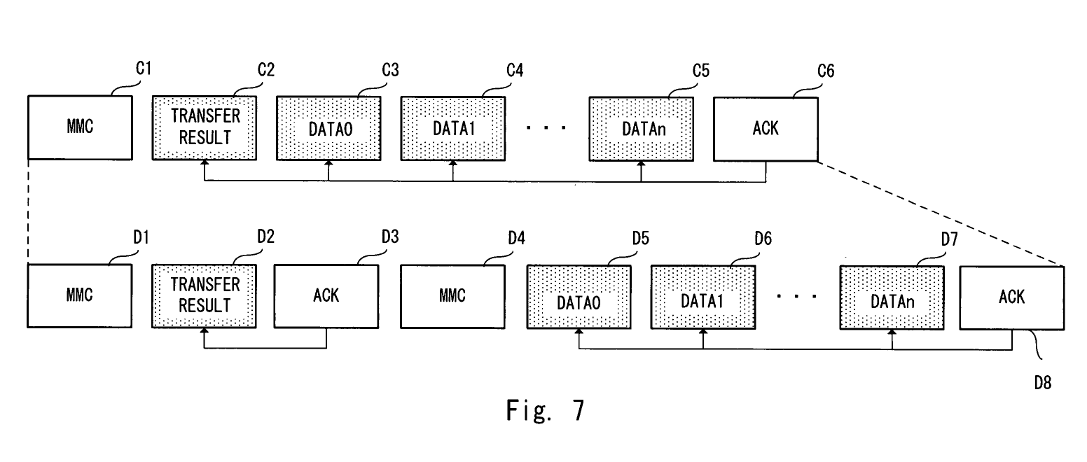

This holds true in IN transfer. FIG. 7 shows a flow of packets in IN transfer in time series. In the figure, the upper part represents a flow in accordance with this embodiment, and the lower part represents a flow in the related art. In FIG. 7, time progresses from left to right, and the difference between hatched packets and other packets is the same as in FIG. 6. In FIG. 7, a packet flow related to Transfer Request is omitted.

A USB host 2 first delivers a MMC (C1), and then sends Transfer Result (C2) and IN data, i.e., DATA 0 (C3) to DATA n (C5) in succession to a DWA 3 in this embodiment in accordance with the present invention. The DWA 3 sends a collective handshake for the Transfer Result (C2) and IN data (C3 to C5) in the form of an ACK (C6) to the USB host 2. On the other hand, a USB host first delivers a MMC (D1), and then sends Transfer Result (D2) to a DWA in the related art. The DWA sends a handshake for the Transfer Result (D2) in the form of an ACK (D3) to the USB host. Then, the USB host delivers a MMC (D4), and then sends IN data, i.e., DATA 0 (D5) to DATA n (D7) to the DWA. The DWA sends a handshake for the IN data (D5 to D7) in the form of an ACK (D8) to the USB host.

As shown in FIG. 7, the number of packets in the procedure to transfer the IN data in this embodiment is fewer by two than in the procedure to transfer the same IN data in the related art. Specifically, the packets for the ACK (D3) and MMC (D4) are eliminated. In addition, while the data transfer direction is changed three times in the related art, it is changed only once in this embodiment, and therefore it can also reduce the number of data transfer direction changes. Furthermore, it also means that the transfers of both Transfer Result and IN data can be accomplished with one MMC. Therefore, additional Transfer Result and IN data can be received with the next MMC. Considering the case where the number of devices connected to a wireless host becomes larger and the time scheduled by one MMC become longer, it improves the transfer efficiency of the DWA.

Incidentally, if the data amount of OUT data or IN data is too large to be allocated to one data transfer unit in FIGS. 4-7, the remaining portion of the OUT data or IN data, which cannot be allocated to one data transfer unit, is allocated to packet(s) in the next data transfer unit, and then transferred. In this case, a MMC is followed by packet(s) to which OUT data or IN data is allocated, and a packet of Transfer Request or Transfer Result is not included in that data transfer unit.

As explained above, a wireless USB communication system or method in accordance with this embodiment allows the collective burst transfer of Transfer Request and its corresponding transfer data, or Transfer Result and its corresponding transfer data, and thereby improving data transfer efficiency. Specifically, the following advantageous effects can be obtained.

(1) Since Transfer Request and its corresponding transfer data, or Transfer Result and its corresponding transfer data are put together in burst transfer, a transmission amount equivalent to one handshake transmission (which is included in a MMC when it is transferred from a USB host 2 to a DWA 3) is eliminated.

(2) Owing to IFS (Interframe spacing: time needed to be inserted between flames/packets) or the like, there is a limit to the reduction in the turnaround time of a MMC. Therefore, it has been time consuming to send Transfer Request and transfer data, or Transfer Result and transfer data in communication procedure in the related art in which separate MMCs are used to make schedules for their transfers. In this embodiment in accordance with the present invention, since Transfer Request and transfer data, or Transfer Result and transfer data are sent together in a burst mode with one MMC to make a schedule for their transfers, it can reduce time needed for transfer direction changes, and thereby enabling the reduction in the total transfer time.

(3) The ratio of packet loss becomes higher to some extent owing to the nature of wireless communication. However, lost packet (s) can be also collectively retransferred by confirming each reception of Transfer Request or Transfer Result and transfer data, and therefore retransmission efficiency can be improved.

Incidentally, recognition of differences between the current standards and the above-explained operation in accordance with one embodiment of the present invention can be achieved by the following modifications.

(I) A bit indicating the support of a communication system or method in accordance with one embodiment of the present invention is added in a descriptor so that a host device recognizes it during enumeration.

(II) A bit indicating the support of a communication system or method in accordance with one embodiment of the present invention is added in an internal reserved area of Transfer Request or Transfer Result.

(III) It is recognized by differentiating the usage of the last packet flag bit of the last packet. Specifically, it can use the fact that while this bit will be set when Transfer Request or Transfer Result is transferred in the current standards since Transfer Request or Transfer Result is transferred as one data transfer unit by itself, the bit will not be set in a communication system or method in accordance with one embodiment of the present invention.

(IV) A USB host 2 or a DWA 3 determines it in the following manner. In the case of OUT transfer, a DWA 3 first receives Transfer Request based on the schedule of a MMC, and then determines that it is in a communication system or method in accordance with one embodiment of the present invention if the DWA 3 receives OUT data subsequent to the Transfer Request, and determines that it is in a communication system or method of the current standards if not so. Likewise, in the case of IN transfer, a USB host 2 first receives Transfer Result, and then determines that it is in a communication system or method in accordance with one embodiment of the present invention if the USB host 2 receives IN data subsequent to the Transfer Result, and determines that it is in a communication system or method of the current standards if not so.

Incidentally, a communication system and data transfer method in accordance with this embodiment of the present invention is not limited to communication between a USB host 2 and a DWA 3 explained above. It may be applied to other relay devices that are used to relay data transfer between a USB host and a wired USB device and uses wireless USB communication system to communicate with the USB host.

Furthermore, FIG. 2 shows components of a USB host 2 and a DWA 3 essential to this embodiment in accordance with one embodiment of the present invention, and other components are omitted. Furthermore, each component is not limited to one shown in the figures, and other components can substitute for them, provided that a USB host 2 and a DWA 3 composed of such components can achieve a communication system in accordance with one embodiment of the present invention by carrying out their respective functions explained in the above-mentioned embodiment.

### Second Embodiment

One type of devices widely used in a wired USB environment is a mass storage class (USB mass storage class). An embodiment in which a communication system in accordance with one embodiment of the present invention is applied to a mass storage class device (called “mass storage device” hereinafter) is explained as a second embodiment hereinafter. Firstly, a mass storage class itself is explained hereinafter.

Although the USB protocol defines data transfer mode alone, a mass storage class defines “class” of general devices by combining several additional transfer modes, and defining a format of transferred data and so on. When a device belongs to a certain “class”, it uses substantially the same control method, and thereby the unification of driver software and the like can be achieved.

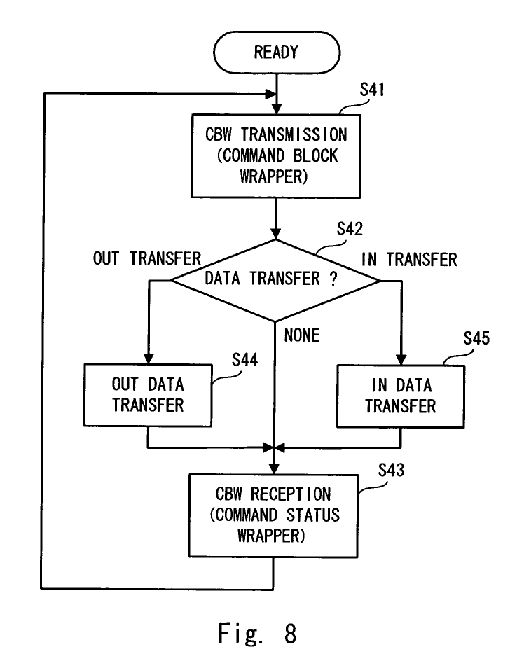

A general USB flash memory and a USB hard drive belong to the class called “mass storage class”. FIG. 8 is a flowchart showing an example of a host process flow in a mass storage class. To control a device in this class, a host first sends a packet called “CBW (Command Block Wrapper)”, which contains information about transfer data length and transfer direction (IN/OUT), executable commands, and the like, to the mass storage device (S41). The mass storage device receives this packet. If it doesn't involve data transfer (non at S42), the mass storage device put the result in a packet called “CSW (Command Status Wrapper)”, and transfers it to the host. The host receives the CSW packet from the mass storage device (S43). A CBW also contains executable commands that have nothing to do with OUT transfer and IN transfer. Therefore, when it doesn't involve data transfer, the mass storage device returns a CSW to the host after it receives a CBW from the host.

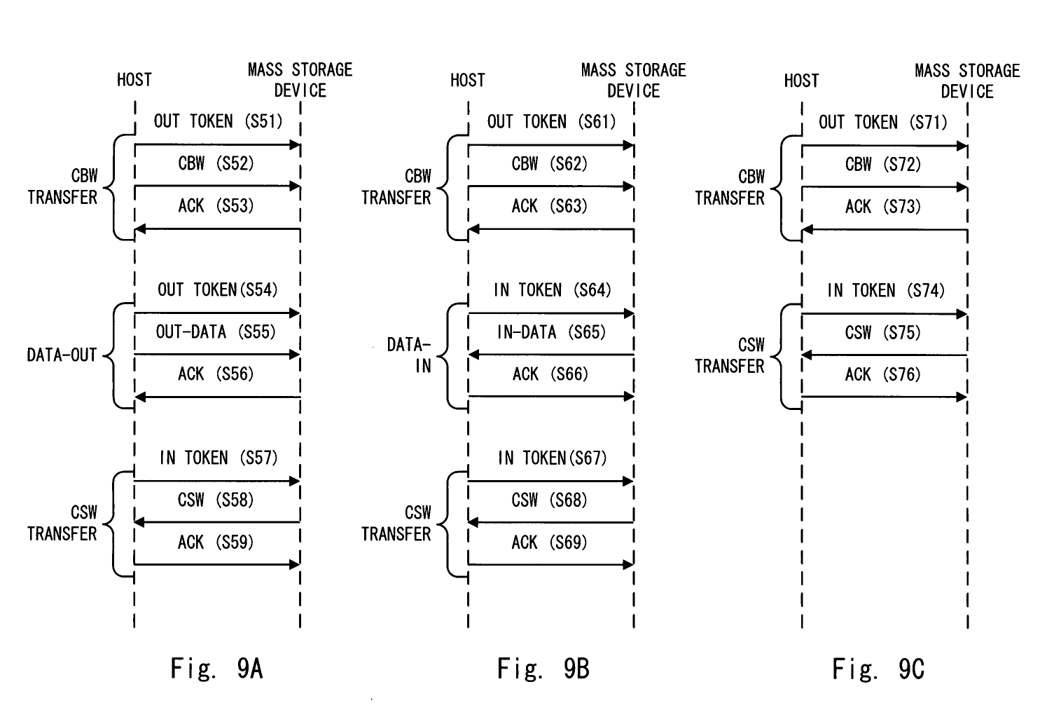

In the case of OUT transfer (host→mass storage device) (OUT transfer at S42), the host sends OUT data to the mass storage device after the transmission of the CBW (S44). Then, it receives the CSW from the mass storage device (S43). In the case of IN transfer (mass storage device→host) (In transfer at S42), the host receives IN data from the mass storage device after the transmission of the CBW (S45), and then receives the CSW from the mass storage device (S43). This embodiment is different from the previous embodiment where a DWA is used in a point that while IN data is sent after Transfer Result in the previous embodiment, a CSW is sent after IN data in the mass storage class. FIGS. 9A to 9C are sequence charts showing data transfer procedures between a mass storage class host and a mass storage device. FIG. 9A shows procedure in OUT transfer, FIG. 9B shows procedure in IN transfer, and FIG. 9C shows procedure in which no data transfers are carried out, but commands are carried out.

If this control scheme is applied to a wireless environment without any modification such that OUT data is sent after confirming the reception of a CBW, or a CSW is sent after confirming the reception of IN data, it can cause a problem that transfer efficiency cannot be improved. However, the transfer efficiency can be improved by applying a control scheme in accordance with one embodiment of the present invention to the procedure such that a CBW and OUT data, and IN data and a CSW can be sent in a series of bursts.

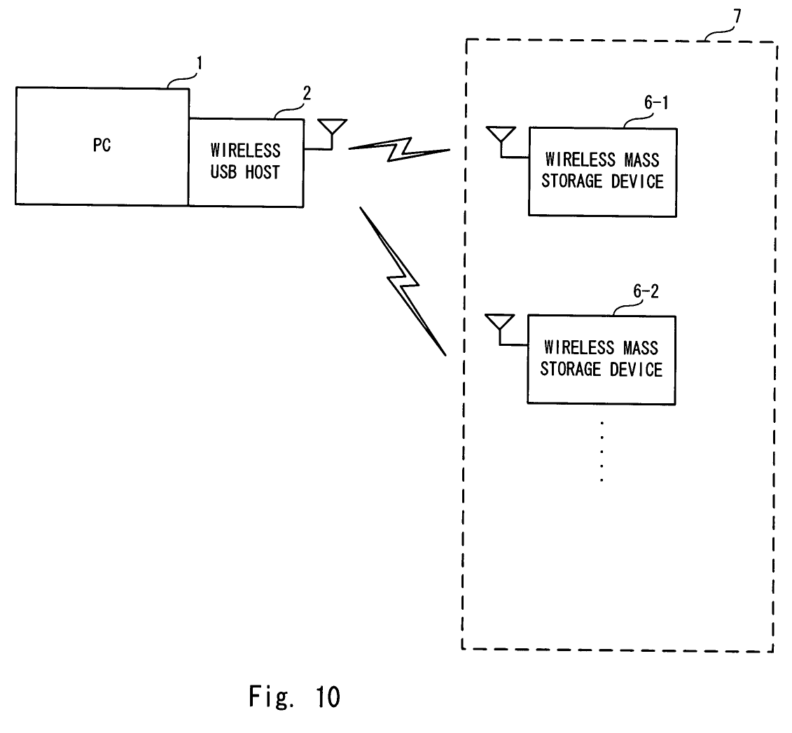

A case where a communication system or method in accordance with one embodiment of the present invention is applied to a mass storage class device is explained hereinafter. FIG. 10 shows a configuration example of a system in which a wireless USB in accordance with one embodiment of the present invention is applied to mass storage class devices. Wireless mass storage devices 6 wirelessly communicate with a USB host 2. Each wireless mass storage devices 6 includes components capable of achieving similar functions to those of the DWA 3 explained with the first embodiment, and a data storage area. In the embodiment shown in FIG. 10, a USB slave 7 is composed of mass storage devices 6.

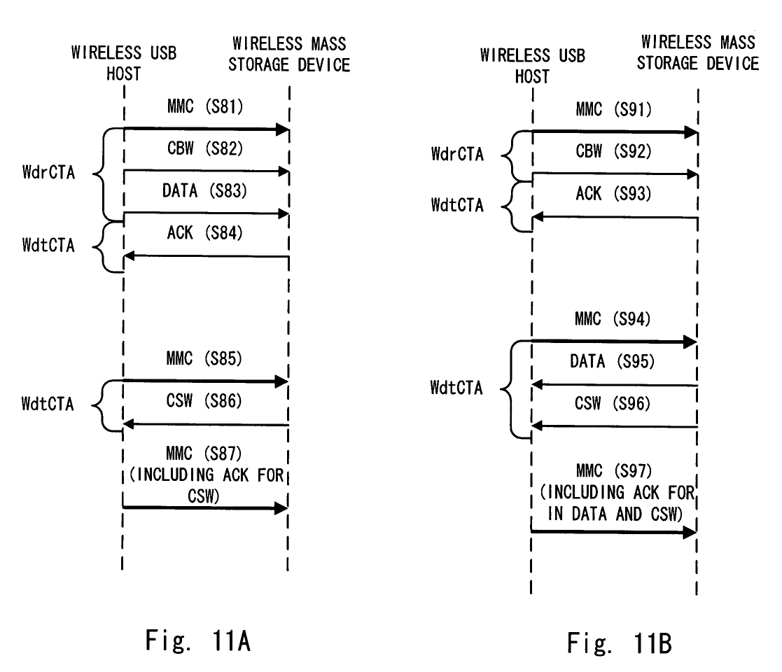

FIGS. 11A and 11B are sequence charts showing one example of data transfer in accordance with a second embodiment of the present invention. FIG. 11A shows OUT transfer, and FIG. 11B shows IN transfer. The details of the operations are the same as those of the first embodiment, and therefore their explanations are omitted. When the sequence charts of FIGS. 11A and 11B are compared to that of FIG. 8, they correspond with each other in the following manner. In OUT transfer, procedures in the CBW transfer (S51 to S53) and OUT data transfer (S54 to S55) correspond with those in the steps S81 to S84. Furthermore, in IN transfer, procedures in the IN data transfer (S64 to S66) and CSW transfer (S67 to S69) correspond with those in the steps S94-S97. However, as explained above, the transfer order of IN data and a CSW is different from that of Transfer Result and IN data of FIG. 5.

As explained above, procedures to confirm reception by a handshake can be reduced, and data transfer direction changes can be also reduced by including a series of transfers needed for data transfer in one data transfer unit in accordance with one preferred embodiment of the present invention. In this manner, it can improve data transfer efficiency.

It is apparent that the present invention is not limited to the above embodiments, but may be modified and changed without departing from the scope and spirit of the invention.

What is claimed is:

1. A USB host to wirelessly communicate with a USB slave, the USB host comprising:
a scheduling portion to generate schedule information, the schedule information determining a data transfer schedule; and
a data control portion to send data transfer request information and transfer data to the USB slave in one data transfer unit based on the schedule information, the data transfer request information specifying data transfer to be requested.

2. The USB host according to claim 1, wherein the data control portion sends at least one packet to the USB slave in one data transfer unit, the data transfer request information and the transfer data being allocated to the at least one packet.

3. The USB host according to claim 1, wherein the data control portion receives a reception result of the data transfer request information and the transfer data by the USB slave as result information for the one data transfer unit.

4. The USB host according to claim 1, wherein the data control portion requests the USB slave for the data transfer based on the schedule information, and receives the transfer data transferred in response to the request and data transfer result information indicating an acquisition result of the transfer data in one data transfer unit from the USB slave.

5. The USB host according to claim 4, wherein the data control portion receives at least one packet in one data transfer unit, the data transfer result information and the transfer data being allocated to the at least one packet.

6. The USB host according to claim 4, wherein the data control portion includes a reception result of the data transfer result information and the transfer data as result information for the one data transfer unit in scheduling information delivered in the next transmission.

7. The USB host according to claim 2, wherein the data control portion carries out data transfer of at least one packet, the number of the packets being equal to or less than the maximum number containable in the one data transfer unit, and the size of the last packet being equal to or less than the size of other packets.

8. The USB host according to claim 5, wherein the data control portion carries out data transfer of at least one packet, the number of the packets being equal to or less than the maximum number containable in the one data transfer unit, and the size of the last packet being equal to or less than the size of other packets.

9. A USB slave to wirelessly communicate with a USB host, the USB slave comprising:
a host side control portion to receive data transfer request information and transfer data from the USB host in one data transfer unit, the data transfer request information specifying requested data transfer; and
a device side control portion to transfer the transfer data to a data storage area based on the data transfer request information.

10. The USB slave according to claim 9, further comprising a buffer to temporarily store data, wherein:
the host side control portion receives at least one packet in one data transfer unit and stores the at least one packet in the buffer, the data transfer request information and the transfer data being allocated to the at least one packet; and
the device side control portion transfers the transfer data stored in the buffer to the data storage area after the data transfer request information and the transfer data are stored in the buffer.

11. The USB slave according to claim 10, wherein the host side control portion sends a reception result of the data transfer request information and the transfer data as result information for the one data transfer unit to the USB host.

12. The USB slave according to claim 9, wherein the host side control portion sends the transfer data obtained from the data storage area in response to the request from the USB host and data transfer result information indicating data acquisition result for the request to the USB host in one data transfer unit.

13. The USB slave according to claim 12, wherein the host side control portion sends at least one packet in one data transfer unit to the USB host, the data transfer result information and the transfer data being allocated to the at least one packet.

14. The USB slave according to claim 10, wherein the host side control portion carries out data transfer of at least one packet, the number of the packets being equal to or less than the maximum number containable in the one data transfer unit, and the size of the last packet being equal to or less than the size of other packets.

15. The USB slave according to claim 9, wherein:
the USB slave includes a wired USB device, and a relay device to relay data transfer between the wired USB device and the USB host;
the relay device includes the host side control portion and the device side control portion; and
the device side control portion establishes connection to the wired USB device as a data storage area.

16. The USB slave according to claim 9, wherein the USB slave is a mass storage device capable of wireless communication; and the mass storage device includes the host side control portion, the device side control portion, and a data storage area.

17. A wireless communication system between a USB host and a USB slave, wherein:
the USB host includes:
a scheduling portion to deliver schedule information, the schedule information determining a data transfer schedule; and
a data control portion to send data transfer request information and transfer data to the USB slave in one data transfer unit based on the schedule information, the data transfer request information specifying data transfer to be requested;
the USB slave includes:
a host side control portion to receive the data transfer request information and the transfer data in succession from the USB host based on the schedule information; and
a device side control portion to transfer the transfer data to a data storage area based on the data transfer request information.

18. A data transfer method for a USB host, the USB host wirelessly communicating with a USB slave, the data transfer method comprising:
generating schedule information, the schedule information determining a data transfer schedule, and
sending data transfer request information and transfer data to the USB slave in one data transfer unit based on the schedule information, the data transfer request information specifying data transfer to be requested.

19. A data transfer method for a USB slave, the USB slave wirelessly communicating with a USB host, the data transfer method comprising:
receiving data transfer request information and transfer data from the USB host, in one data transfer unit, based on data transfer request information sent from the USB host, the data transfer request information specifying requested data transfer.

20. A data transfer method through wireless communication between a USB host and a USB slave, wherein:
the USB host sends data transfer request information and transfer data to the USB slave in one data transfer unit based on schedule information, the data transfer request information specifying data transfer to be requested, and the schedule information determining a schedule for data transfer with the USB slave; and
the USB slave receives the data transfer request information and the transfer data in succession from the USB host.
